(19) United States
(12) Patent Application Publication
(10) Pub. No.: US 2012/0050599 A1
(43) Pub. Date: Mar. 1, 2012

(54) IMAGE SENSING DEVICE

(75) Inventor: HUI-HSUAN CHEN, HSINCHU (TW)

(73) Assignee: PixArt Imaging Inc., Hsinchu (TW)

(21) Appl. No.: 13/027,538

(22) Filed: Feb. 15, 2011

(30) Foreign Application Priority Data
Aug. 25, 2010 (TW) 099128537

(51) Int. Cl. H04N 9/07

(52) U.S. Cl. 348/336; 348/E09.003

(57) ABSTRACT

An image sensing device includes a substrate, a color filter layer, a plurality of micro-lenses and a plurality of anti-reflection units. The substrate has a plurality of sensing units, and the color filter layer covers the sensing units. The micro-lenses are disposed on the color filter layer, and the micro-lenses are respectively corresponded to the sensing units. Moreover, the anti-reflection units are respectively disposed on the micro-lenses. Each anti-reflection unit includes a plurality of anti-reflection films stacked on the corresponding micro-lens, and refractive indexes of the two adjacent anti-reflection films are different. The image sensing device has a better image sensing quality.

### FIELD OF THE INVENTION

The present invention relates to an image sensing device, and more particularly to an image sensing device having anti-reflecting films.

### BACKGROUND OF THE INVENTION

Image sensing devices have been widely used in many electronic products, such as digital cameras, mobile phones, video cameras, scanners and so on. The common image sensing devices include a charge coupled device (CCD) and a complementary metal oxide semiconductor (CMOS) image sensing device. The image sensing device generally includes a substrate and a plurality of sensing units formed on the substrate. The sensing units are arranged in an array and are configured to detect light.

In order to enable the image sensing device to detect a color image, a color filter layer is generally formed on the substrate. Moreover, in order to promote a sensing range of each sensing unit, micro-lenses are disposed on the color filter layer, wherein the micro-lenses are respectively corresponded to the sensing units.

The micro-lenses can promote the sensing ranges of the sensing units. However, a light incident efficiency of each micro-lens is bad, and thereby stray light is easily generated when light enters the micro-lenses. In such way, each sensing unit easily detects the stray light from the adjacent micro-lenses. Thus, a quality of image detected by the image sensing device is poor.

### SUMMARY OF THE INVENTION

The present invention provides an image sensing device to promote an image sensing quality.

To achieve the above-mentioned advantage, the present invention provides an image sensing device. The image sensing device includes a substrate, a color filter layer, a plurality of micro-lenses and a plurality of anti-reflection units. The substrate has a plurality of sensing units, and the color filter layer covers the sensing units. The micro-lenses are disposed on the color filter layer, and the micro-lenses are respectively corresponded to the sensing units. Moreover, the anti-reflection units are respectively disposed on the micro-lenses. Each anti-reflection unit includes a plurality of anti-reflection films stacked on the corresponding micro-lens, and refractive indexes of the two adjacent anti-reflection films are different.

In one embodiment of the present invention, each anti-reflection unit includes a first anti-reflection film and a second anti-reflection film. The first anti-reflection film is disposed on the corresponding micro-lens. The second anti-reflection film is disposed on the first anti-reflection film, and the refractive index of the first anti-reflection film is smaller than the refractive index of the second anti-reflection film.

In one embodiment of the present invention, each anti-reflection unit includes a plurality of first anti-reflection films and a plurality of second anti-reflection films. The first anti-reflection films and the second anti-reflection films are alternately stacked on the corresponding micro-lens. One of the first anti-reflection films abuts the corresponding micro-lens, and the refractive index of the first anti-reflection films is smaller than the refractive index of the second anti-reflection films.

In one embodiment of the present invention, the refractive index of the first anti-reflection films is N1, the refractive index of the second anti-reflection films is N2, and N2 is larger than or is equal to N1.

In one embodiment of the present invention, the image sensing device further includes a protecting layer. The protecting layer is disposed between the substrate and the color filter layer.

In one embodiment of the present invention, material of the anti-reflection films includes titanium dioxide (TiO₂), magnesium fluoride (MgF₂) or zinc fluoride (ZnF₂).

In the image sensing device of the present invention, since the anti-reflection units are respectively disposed the micro-lenses, a light incident efficiency of the micro-lenses can be promoted, so as to prevent stray light from being caused. Therefore, a quantity of the stray light sensed by the sensing units is reduced, and thus the image sensing device of the present invention has a better image sensing quality.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic view of an image sensing device according to an embodiment of the present invention.

FIG. 2 is a schematic view of an image sensing device according to another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

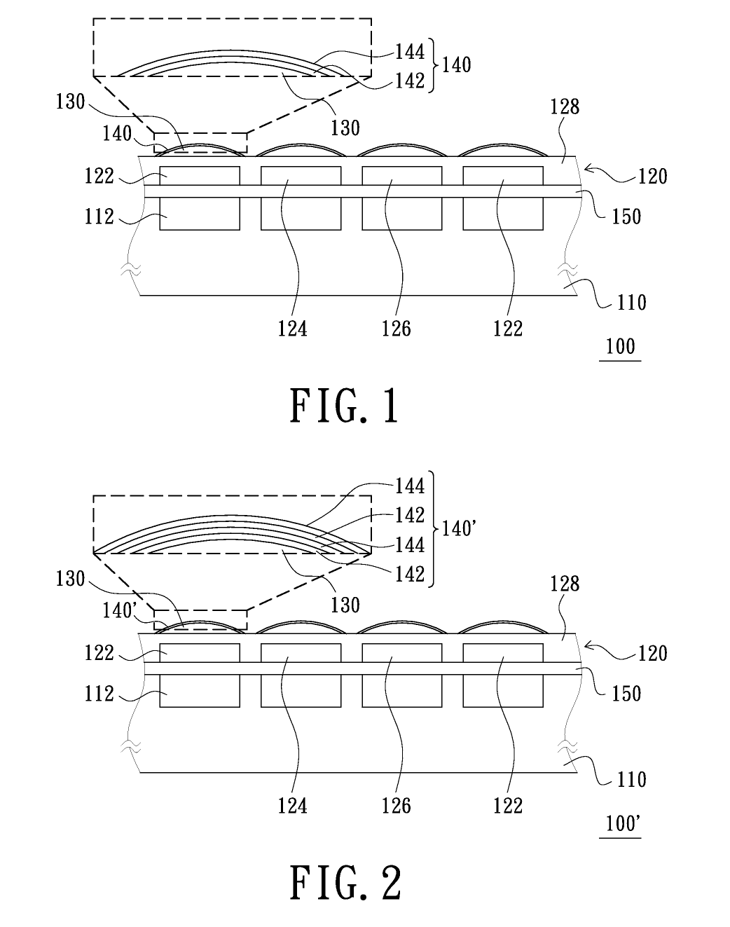

FIG. 1 is a schematic view of an image sensing device according to an embodiment of the present invention. Referring to FIG. 1, an image sensing device 100 of the present embodiment can be, but not limited to, a CCD or a CMOS image sensing device. The image sensing device 100 includes a substrate 110, a color filter layer 120, a plurality of micro-lenses 130 and a plurality of anti-reflection units 140. The substrate 110 has a plurality of sensing units 112, and the sensing units 112 are covered by the color filter layer 120. The micro-lenses 130 are disposed on the color filter layer 120 and are respectively corresponded to the sensing units 112. Moreover, the anti-reflection units 140 are respectively disposed on the micro-lenses 130.

The above-mentioned substrate 110 is, for example, a silicon substrate. The sensing units 112 disposed on the substrate 110 are, for example, arranged in an array, and the sensing units 112 are configured to detect light. Furthermore, the color filter layer 120 includes a plurality of color filter patterns, such as color filter patterns 122, 124, 126. Material of the color filter patterns 122, 124, 126 is, for example, color photoresist. The colors of the color filter patterns 122, 124, 126 can be different. For instance, the color of the color filter pattern 122 is, for example, red, the color of the color filter pattern 124 is, for example, green, and the color of the color filter pattern 126 is, for example, blue. In addition, the color filter layer 120 can further include a flat layer 128 which is configured to cover the color filter patterns 122, 124, 126. Material of the flat layer 128 is transparent, such as transparent polymer material. However, the present invention does not limit the material of the flat layer 128.

The above-mentioned image sensing device 100 can further include a protecting layer 150. The protecting layer 150 is disposed between the substrate 110 and the color filter layer 120. In other words, the protecting layer 150 is formed on the substrate 110, so as to protect the sensing units 112. The color filter layer 120 is formed on the protecting layer 150. Moreover, material of the protecting layer 150 can be silicon oxide, silicon nitride or other suitable material.

The above-mentioned micro-lenses 130 are used to promote sensing ranges of the sensing units 112, and material of the micro-lenses 130 can be photoresist material with a high transmittance. In addition, the anti-reflection units 140 disposed on the micro-lenses 130 are used to promote a light incident efficiency of the micro-lenses 130, so as to prevent stray light from being caused. Each anti-reflection unit 140 includes a plurality of anti-reflection films stacked on the corresponding micro-lens 130, and refractive indexes of the two adjacent anti-reflection films are different. Furthermore, material of the anti-reflection films can be titanium dioxide, magnesium fluoride, zinc fluoride or other suitable material.

More specifically, each anti-reflection unit 140 of the present embodiment includes, for example, a first anti-reflection film 142 and a second anti-reflection film 144. The first anti-reflection film 142 is disposed on the corresponding micro-lens 130. The second anti-reflection film 144 is disposed on the first anti-reflection film 142, and the refractive index N1 of the first anti-reflection film 142 is smaller than the refractive index N2 of the second anti-reflection film 144. Additionally, in order to raise an anti-reflection function of the anti-reflection units 140, N2 can be larger than or be equal to N1.

In the present embodiment, since the anti-reflection units 140 disposed on the micro-lenses 130 can prevent the stray light from being caused, a quantity of the stray light sensed by the sensing units 112 can be reduced. Thus, an image sensing quality of the image sensing device 100 of the present embodiment can be promoted.

FIG. 2 is a schematic view of an image sensing device according to another embodiment of the present invention. Referring to FIG. 2, an image sensing device 100′ of the present embodiment is similar to the image sensing device 100 of FIG. 1, the difference is the anti-reflection units. More specifically, each anti-reflection unit 140′ of the image sensing device 100′ of the present embodiment includes two first anti-reflection films 142 and two second anti-reflection films 144. The first anti-reflection films 142 and the second anti-reflection films 144 are alternately stacked on the corresponding micro-lens 130, and one of the first anti-reflection films 142 abuts the corresponding micro-lens 130. Moreover, the refractive index N1 of the first anti-reflection films 142 is smaller than the refractive index N2 of the second anti-reflection films 144.

Compared to the anti-reflection units 140 of the image sensing device 100 of FIG. 1, the anti-reflection units 140′ of the image sensing device 100′ of the present embodiment includes more anti-reflection films, so the quantity of the stray light is further reduced. In such way, the quantity of the stray light sensed by the sensing units 112 can be reduced. Therefore, the image sensing device 100′ has a better image sensing quality.

It should be noted that, a number of the anti-reflection films of each anti-reflection unit of the present invention can be more than two and is not limited to two or four. Moreover, in other embodiments, the anti-reflection films of each anti-reflection unit can have more than two refractive indexes.

In summary, since the anti-reflection units are respectively disposed on the micro-lenses of the image sensing device of the present invention, the light incident efficiency of the micro-lenses can be promoted and the quantity of the stray light can also be reduced. Thereby, the quantity of the stray light detected by the sensing units is reduced, so the image sensing device of the present invention has the better image sensing quality.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An image sensing device comprising:
a substrate having a plurality of sensing units;
a color filter layer covering the sensing units;
a plurality of micro-lenses disposed on the color filter layer, and the micro-lenses being respectively corresponded to the sensing units; and
a plurality of anti-reflection units respectively disposed on the micro-lenses, each anti-reflection unit comprising a plurality of anti-reflection films stacked on the corresponding micro-lens, and refractive indexes of the two adjacent anti-reflection films being different.

2. The image sensing device according to claim 1, wherein each anti-reflection unit comprising:
a first anti-reflection film disposed on the corresponding micro-lens; and
a second anti-reflection film disposed on the first anti-reflection film, and the refractive index of the first anti-reflection film being smaller than the refractive index of the second anti-reflection film.

3. The image sensing device according to claim 1, wherein each anti-reflection unit comprises a plurality of first anti-reflection films and a plurality of second anti-reflection films, the first anti-reflection films and the second anti-reflection films are alternately stacked on the corresponding micro-lens, one of the first anti-reflection films abuts the corresponding micro-lens, and the refractive index of the first anti-reflection films is smaller than the refractive index of the second anti-reflection films.

4. The image sensing device according to claim 1, wherein material of the anti-reflection films comprises titanium dioxide, magnesium fluoride or zinc fluoride.

5. The image sensing device according to claim 1, further comprising a protecting layer disposed between the substrate and the color filter layer.
